(19) United States
(12) Patent Application Publication
(10) Pub. No.: US 2011/0297673 A1
(43) Pub. Date: Dec. 8, 2011

(54) WAVE CHOKE SYSTEM FOR A DOOR OF A MICROWAVE OVEN

(75) Inventors: Abdel-Ilah Zbat, Wurzburg (DE); Arnd Hofmann, Schallfeld (DE)

(73) Assignee: ELECTROLUX HOME PRODUCTS CORPORATION N.V., Brussel (BE)

(21) Appl. No.: 13/202,415

(22) PCT Filed: Mar. 26, 2010
(86) PCT No.: PCT/EP10/01934

§ 371 Date: Aug. 19, 2011

(30) Foreign Application Priority Data
Apr. 3, 2009 (EP) 09004935.4

(51) Int. Cl. H05B 6/64

(52) U.S. Cl. 219/756

(57) ABSTRACT

The present invention relates to a wave choke system for a door of a microwave oven. The wave choke system comprises at least one wave trap (10) formed as an elongated channel and bordered by four channel walls (22, 24, 32, 34) made of one or more conductive materials and by at least one gap (28). The wave trap (10) is provided for extending at least partially along a door frame and/or along a cavity frame (12). The wave trap (10) comprises at least two adjoining wave choke recesses (14, 16) for a λ/4 transformation parallel to each other and parallel to the wave trap (10). Two neighbouring wave choke recesses (14, 16) are separated by an elongated wave barrier (18) made of one or more conductive materials. The height of the wave barrier (18) is lower than the height of the wave trap (10).

The present invention relates to a wave choke system for a door of a microwave oven according to the preamble of claim 1. Further, the present invention relates to an over door for a microwave oven according to claim 11. Additionally, the present invention relates to a microwave oven according to claim 15.

Microwave ovens generate strong electromagnetic fields in order to heat food stuff and beverages. However, said strong electromagnetic fields are a potential threat to the health of the operator, if the electromagnetic fields or parts of them leave the cavity of the microwave oven. The door of the microwave oven is the most critical part. In particular, microwaves may leave the cavity through the gap between the door and the frame of the cavity.

Usually, the gap between the oven door and the cavity is sealed with respect to microwaves by integrating wave chokes into the door and/or onto the frame of the cavity. Such wave choke systems base on a λ/4 transformation. However, mechanical tolerances of the cavity frame and the frame of the oven door can evoke local areas of an increased leakage.

It is an object of the present invention to provide an improved wave choke system for a door of a microwave oven, wherein said wave choke system allows a reduced leakage of microwaves.

This object is achieved by the wave choke system according to claim 1.

According to the present invention two neighbouring wave choke recesses are separated by an elongated wave barrier made of one or more conductive materials, wherein the height of the wave barrier is lower than the height of the wave trap.

The main idea of the present invention is the arrangement of two λ/4 transformation wave choke recesses separated by a wave barrier between them, wherein the height of the wave barrier is lower than the height of the wave trap. The inventive wave choke system allows a reduced leakage of microwaves. Further, the structure of the inventive wave choke system allows a low complexity. Thus, the wave choke system according to the present invention may be realized by low costs.

According to a preferred embodiment of the present invention the one wave choke recess is covered completely by an inner channel wall and another wave choke recess is covered partially by the gap and partially by the inner channel wall. This structure forms the wave choke system with two asymmetrical λ/4 transformation wave choke recesses.

Further, the wave barrier may extend from an outer channel wall to the interior of the wave trap. Otherwise, the wave barrier may also extend along the longitudinal axis of the wave trap.

In particular, the wave barrier is formed as a massive wall. Holes or slots are not provided within the wave barrier.

For example, the wave barrier is formed as an I-shaped profile rail. Thereby the wave barrier and an outer channel wall may be formed as a single-piece T-shaped profile rail.

Further, the wave barrier, an outer channel wall, an outer circumferential channel wall and an inner circumferential channel wall may be formed as a single-piece E-shaped profile rail.

Alternatively the wave barrier may be formed as a U-shaped profile rail, wherein the arc of the U-shaped profile rail is arranged in the interior of the wave trap.

Also in this case, the U-shaped wave barrier and the outer channel wall can be formed as a single-piece profile rail.

Further, the present invention relates to an oven door for a microwave oven, wherein the oven door comprises at least one wave choke system as described above.

In particular, the oven door comprises at least one transparent panel forming the inner side of said oven door.

According to the preferred embodiment of the present invention the wave trap is arranged at the outer side of the transparent panel, wherein at least an inner channel wall is attached at the transparent panel.

For example, the transparent panel is made of glass.

At last, the present invention relates to microwave oven, wherein the microwave oven comprises at least one wave choke system and/or at least one oven door as described above.

The novel and inventive features believed to be the characteristic of the present invention are set forth in the appended claims.

The invention will be described in further detail with reference to the drawing, in which

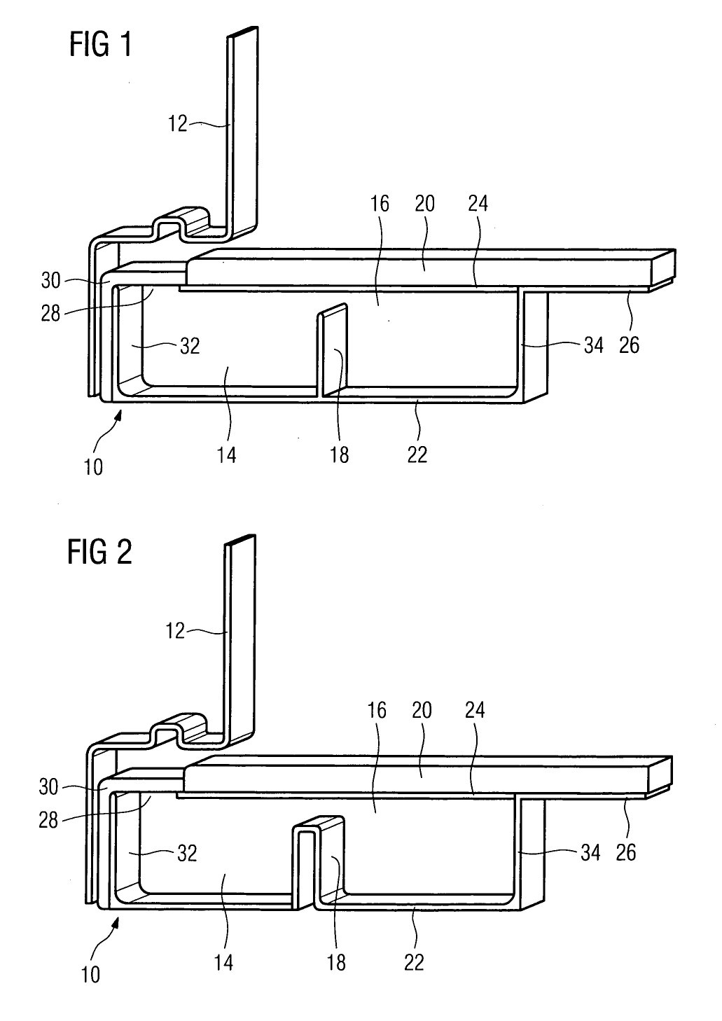

FIG. 1 illustrates a perspective view of a section of a wave choke system for a door of a microwave oven according to a first embodiment of the present invention, and

FIG. 2 illustrates a perspective view of a section of a wave choke system for a door of a microwave oven according to a second embodiment of the present invention.

FIG. 1 illustrates a perspective view of a section of a wave choke system for a door of a microwave oven according to a first embodiment of the present invention. The cross section of the illustrated section corresponds with the cross section of the whole wave choke system.

The wave choke system comprises a wave trap 10 formed as a channel with a substantially rectangular cross section. The wave trap 10 is bordered by an outer channel wall 22, an inner channel wall 24, an outer circumferential channel wall 32 and an inner circumferential channel wall 34. The outer channel wall 22, the inner channel wall 24, the outer circumferential channel wall 32 and the inner circumferential channel wall 34 are made of an electrically conductive material, in particular made of metal.

The wave trap 10 is arranged within a door frame of an oven door. A section of the wave trap 10 is shown in FIG. 1. The wave trap 10 encloses circumferentially the oven door completely or at least partially. The wave trap 10 forms a part or an appendix of the door frame. In a closed state of the oven door the wave trap 10 extends besides a cavity frame 12. A section of the cavity frame 12 corresponding to the section of the wave trap 10 is also shown in FIG. 1.

The wave trap 10 of the wave choke system comprises a first wave choke recess 14 and a second wave choke recess 16. The first wave choke recess 14 and the second wave choke recess 16 are arranged parallel to each other and parallel to the wav trap 10. The first wave choke recess 14 and the second wave choke recess 16 are formed as open channels. The open sides of the first wave choke recess 14 and second wave choke recess 16 are directed to the oven cavity. The first wave choke recess 14 encloses circumferentially the second wave choke recess 16. The first wave choke recess 14 and the second wave choke recess 16 are provided for a λ/4 transformation. In this example, the first wave choke recess 14 and the second wave choke recess 16 have the widths.

Between the first wave choke recess 14 and the second wave choke recess 16 a wave barrier 18 is arranged. Thus, the first wave choke recess 14 and the second wave choke recess 16 are separated by the wave barrier 18. The wave barrier 18 is made of an electrically conductive material, in particular made of metal. The wave barrier 18 is formed as an I-shaped profile rail. The wave barrier 18 is arranged at the outer channel wall 22 inside the wave trap 10.

In this embodiment, the outer channel wall 22 and the wave barrier 18 form together a T-shaped profile rail. Further, the outer channel wall 22, the outer circumferential channel wall 32, the inner circumferential channel wall 34 and the wave barrier 18 form together an E-shaped profile rail. In this embodiment, the inner channel wall 24 is formed as a separate part. There is no electric contact between the wave barrier 18 and the inner channel wall 24.

Further, a frame element 26 is attached at the inner circumferential channel wall 34. The frame element 26 is arranged perpendicular to the inner circumferential channel wall 34, so that the frame element 26 and the inner circumferential channel wall 34 form an L-shaped profile rail. The frame element 26 extends into the inner portion of the oven door. In this embodiment, the outer circumferential channel wall 32, the outer channel wall 22, the wave barrier 18, the inner circumferential channel wall 34 and the frame element 26 form a single-piece part.

The oven door comprises a transparent panel 20 provided to cover the opening of the oven cavity. The transparent panel 20 permit a view inside the oven cavity. The wave trap 10 is attached at the outer portion of the transparent panel 20. The wave trap 10 is at the outside of the transparent panel 20. The inner channel wall 24 of the wave trap 10 and the frame element 26 are attached at the transparent panel 20. In particular, the transparent panel 20 is made of glass.

The inner channel wall 24 comprises a gap 28 besides the outer circumferential channel wall 32. Except said gap 28, the wave trap 10 is completely enclosed by the electrically conductive outer channel wall 22, outer circumferential channel wall 32, inner channel wall 24 and inner circumferential channel wall 34. In a closed state of the oven door the gap 28 is arranged face to face with a step of the cavity frame 12.

In this embodiment, the gap 28 and an outside of the outer circumferential channel wall 32 are covered by a cover element 30. The cover element 30 is made of an electrically non-conductive material and formed as an L-shaped profile rail. The cover element 30 is provided to prevent the infiltration of non-desirable particles and substances into the first wave choke recess 14 and second wave choke recess 16 of the wave trap 10.

FIG. 2 illustrates a perspective view of a section of a wave choke system for microwave oven according to a second embodiment of the present invention. Identical, corresponding and similar elements of the wave choke system have the same reference numerals as in FIG. 1. The cross section of the illustrated section corresponds with the cross section of the whole wave choke system.

The wave choke system of the second embodiment comprises also the wave trap 10 with the substantially rectangular cross section. The wave trap 10 is provided to be arranged at or within the door frame of the microwave oven. The wave trap 10 encloses completely or at least partially circumferentially the oven door. The wave trap 10 is a part or the appendix of the door frame. In the closed state of the oven door the wave trap 10 extends along the cavity frame.

The wave trap 10 of the wave choke system according to the second embodiment comprises also the first wave choke recess 14 and the second wave choke recess 16. The first wave choke recess 14 and the second wave choke recess 16 are arranged parallel to each other and parallel to the wave trap 10. The first wave choke recess 14 and the second wave choke recess 16 are also formed as open channels. The open sides of the first wave choke recess 14 and second wave choke recess 16 are directed to the oven cavity. The first wave choke recess 14 encloses circumferentially the second wave choke recess 16. The first wave choke recess 14 and the second wave choke recess 16 are provided for a λ/4 transformation. Also in this example, the first wave choke recess 14 and the second wave choke recess 16 have the widths.

Between the first wave choke recess 14 and the second wave choke recess 16 the wave barrier 18 is arranged. The first wave choke recess 14 and the second wave choke recess 16 are also separated by the wave barrier 18. The wave barrier 18 is made of an electrically conductive material, in particular made of metal.

The only difference between the first embodiment in FIG. 1 and the second embodiment in FIG. 2 is the geometric structure of the wave barrier 18. In the second embodiment the wave barrier 18 is formed as a U-shaped profile rail. Said U-shaped profile rail interrupts the outer channel wall 22 of the wave trap 10, so the wave barrier 18 and the outer channel wall 22 form a single-piece profile rail. The arc of the U-shaped profile rail is directed to the inner channel wall 24 and is arranged in the interior of the wave trap 10. However, there is no electric contact between the wave barrier 18 and the inner channel wall 24.

The frame element 26 is attached at the inner circumferential channel wall 34. The frame element 26 is arranged perpendicular to the inner circumferential channel wall 34, so that the frame element 26 and the inner circumferential channel wall 34 form the L-shaped profile rail. The frame element 26 extends into the inner portion of the oven door. Also in this embodiment, the outer circumferential channel wall 32, the outer channel wall 22, the wave barrier 18, the inner circumferential channel wall 34 and the frame element 26 form a single-piece part.

The oven door comprises the transparent panel 20 provided to cover the opening of the oven cavity. The transparent panel 20 permit the view inside the oven cavity. The wave trap 10 is attached at the outer portion of the transparent panel 20. The wave trap 10 is at the outside of the transparent panel 20. The inner channel wall 24 of the wave trap 10 and the frame element 26 are attached at the transparent panel 20. In particular, the transparent panel 20 is made of glass.

The inner channel wall 24 comprises also the gap 28 besides the outer circumferential channel wall 32. Except said gap 28, the wave trap 10 is completely enclosed by the electrically conductive outer channel wall 22, outer circumferential channel wall 32, inner channel wall 24 and inner circumferential channel wall 34. In the closed state of the oven door the gap 28 is arranged face to face with a step of the cavity frame 12.

Also in this embodiment, the gap 28 and the outside of the outer circumferential channel wall 32 are covered by the cover element 30. The cover element 30 is made of the electrically non-conductive material and formed as the L-shaped profile rail. The cover element 30 is provided to prevent the infiltration of the non-desirable particles and substances into the first wave choke recess 14 and second wave choke recess 16 of the wave trap 10.

The first wave choke recess 14 as well as the second wave choke recess 16 have a rectangular cross section.

The height of the wave barrier is lower than the height of the wave trap. Preferably, height of the wave barrier is higher than the half height of the wave trap. In the first and second embodiment of the present invention the height of the wave barrier is about three-fourth of the height of the wave trap.

Further embodiments of the wave choke system according to the present invention may be realized. For example, the geometric structure of the wave barrier 18 can be varied.

The wave trap 10 according to the present invention with the first wave choke recess 14 and the second wave choke recess 16 and the wave barrier 18 between them allows an improved sealing of microwaves. The leakage between the oven door and the cavity frame is reduced. The inventive wave choke system has a higher bandwidth. The functionality of the wave choke system according to the present invention is more robust against mechanical tolerances of the cavity walls and of the cavity frame. At last, the inventive wave choke system can be produced in an easy way.

Although illustrative embodiments of the present invention have been described herein with reference to the accompanying drawing, it is to be understood that the present invention is not limited to those precise embodiments and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 wave trap
12 cavity frame
14 first wave choke recess
16 second wave choke recess
18 wave barrier
20 transparent panel
22 outer channel wall
24 inner channel wall
26 frame element
28 gap
30 cover element
32 outer circumferential channel wall
34 inner circumferential channel wall

1. A wave choke system for a door of a microwave oven, wherein said wave choke system comprises at least one wave trap (10) formed as an elongated channel and bordered by four channel walls (22, 24, 32, 34) made of one or more conductive materials and by at least one gap (28), wherein the wave trap (10) is provided for extending at least partially along a door frame and/or along a cavity frame (12) and comprises at least two adjoining wave choke recesses (14, 16) for a λ/4 transformation parallel to each other and parallel to the wave trap (10), characterized in, that two neighbouring wave choke recesses (14, 16) are separated by an elongated wave barrier (18) made of one or more conductive materials, wherein the height of the wave barrier (18) is lower than the height of the wave trap (10).

2. The wave choke system according to claim 1, characterized in, that one wave choke recess (16) is covered completely by an inner channel wall (24) and another wave choke recess (14) is covered partially by the gap (28) and partially by the inner channel wall (24).

3. The wave choke system according to claim 1, characterized in, that the wave barrier (18) extends from an outer channel wall (22) to the interior of the wave trap (10).

4. The wave choke system according to claim 1, characterized in, that the wave barrier (18) extends along the longitudinal axis of the wave trap (10).

5. The wave choke system according to claim 1, characterized in, that the wave barrier (18) is formed as a massive wall.

6. The wave choke system according to claim 1, characterized in, that the wave barrier (18) is formed as an I-shaped profile rail.

7. The wave choke system according to claim 6, characterized in, that the wave barrier (18) and an outer channel wall (22) are formed as a single-piece T-shaped profile rail.

8. The wave choke system according to claim 6, characterized in, that the wave barrier (18), an outer channel wall (22), an outer circumferential channel wall (32) and an inner circumferential channel wall (34) are formed as a single-piece E-shaped profile rail.

9. The wave choke system according to claim 1, characterized in, that the wave barrier (18) is formed as a U-shaped profile rail, wherein the arc of the U-shaped profile rail is arranged in the interior of the wave trap 10.

10. The wave choke system according to claim 9, characterized in, that the U-shaped wave barrier (18) and the outer channel wall (22) are formed as a single-piece profile rail.

11. An oven door for a microwave oven, characterized in, that the oven door comprises at least one wave choke system according to claim 1.

12. The oven door according to claim 11, characterized in, that the oven door comprises at least one transparent panel (20) forming the inner side of said oven door.

13. The oven door according to claim 12, characterized in, that the wave trap (10) is arranged at the outer side of the transparent panel (20), wherein at least an inner channel wall (24) is attached at the transparent panel (20).

14. The wave choke system according to claim 8, characterized in, that the transparent panel (20) is made of glass.

15. (canceled)
